(19) United States
(12) Patent Application Publication
(10) Pub. No.: US 2018/0288510 A1
(43) Pub. Date: Oct. 4, 2018

(54) Utensil Attachment

(71) Applicant: Rosa Ortega, Bronx, NY (US)

(72) Inventor: Rosa Ortega, Bronx, NY (US)

(21) Appl. No.: 15/935,355

(22) Filed: Mar. 26, 2018

Related U.S. Application Data
(60) Provisional application No. 62/477,727, filed on Mar. 28, 2017.

(51) Int. Cl. H04R 1/02; A47G 21/02; A47G 21/04; H04R 3/00

(52) U.S. Cl. CPC H04R 1/026; A47G 21/023; H04R 3/00; H04R 1/025; A47G 21/04

(57) ABSTRACT

A utensil attachment. The utensil attachment includes a base having an upper side and a lower side. A housing is affixed to the upper side of the base, and a fastener is affixed to the lower side of the base. A power supply is operably connected to a motion sensor and an audio playback mechanism, wherein the audio playback mechanism includes a speaker disposed on the housing. The motion sensor is configured to detect movement of the housing, and the audio playback mechanism is configured to activate and emit sound through the speaker if the motion sensor detects no motion for a predetermined amount of time. The device can be secured to a child's eating utensil, whereby the sounds emitted by the speaker provide encouragement the child to eat their food.

### CROSS REFERENCE TO RELATED APPLICATIONS

This application claims the benefit of U.S. Provisional Application No. 62/477,727 filed on Mar. 28, 2017. The above identified patent application is herein incorporated by reference in its entirety to provide continuity of disclosure.

### BACKGROUND OF THE INVENTION

The present invention relates to devices that are attachable to eating utensils. More specifically, the present invention provides a sound-emitting utensil attachment that can be removably secured to a child's eating utensil and utilized to encourage the child to eat their food.

It is important for children to eat regular meals in order to advance proper growth and development. However, some children can become easily distracted and stop eating before they have consumed enough food. Additionally, children can often be picky or stubborn eaters. Many times, when a parent or guardian tries to convince a child to eat, the child refuses to do so. It can be difficult to encourage a child to eat with words of encouragement alone. Further, a parent or guardian has to spend time encouraging the child to eat rather than consuming their own food, which can be frustrating to the parent and guardian. Food that is not consumed by a child is often thrown away, which is undesirably wasteful and costly. Some devices exist that are utilized to monitor food intake, such as by counting a number of bites or illuminating portions of a food plate. However, these devices are designed to encourage limiting of food intake, and do not provide encouragement for children to consume their food. In order to address these concerns, the present invention provides a utensil attachment that automatically emits encouraging sounds and messages to encourage a child to eat their food.

In light of the devices disclosed in the known art, it is submitted that the present invention substantially diverges in design elements from the prior art and consequently it is clear that there is a needed in the art for an improvement to existing utensil attachments and eating encouragement devices. In this regard the present invention substantially fulfills these needs.

### SUMMARY OF THE INVENTION

In view of the foregoing disadvantages inherent in the known types of utensil attachments now present in the known art, the present invention provides a utensil attachment wherein the same can be utilized for providing convenience for the user when encouraging a child to consume an adequate amount of food. The utensil attachment includes a base having an upper side and a lower side. A housing is affixed to the upper side of the base, and a fastener is affixed to the lower side of the base. A power supply is operably connected to a motion sensor and an audio playback mechanism, wherein the audio playback mechanism includes a speaker disposed on the housing. The motion sensor is configured to detect movement of the housing, and the audio playback mechanism is configured to activate and emit sound through the speaker if the motion sensor detects no motion for a predetermined amount of time.

One object of the present invention is to provide a utensil attachment that can be removably secured to various types of utensils.

Another object of the present invention is to provide a utensil attachment including a speaker that automatically emits encouraging sounds and methods in order to encourage children to consume an adequate amount of food.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a utensil attachment according to the present invention.

FIG. 2 shows a side view of a utensil attachment according to the present invention being removably secured to an eating utensil.

FIG. 3 shows a diagram of the electronic components of a utensil attachment according to the present invention.

### DETAILED DESCRIPTION OF THE INVENTION

Reference is made herein to the attached drawings. Like reference numerals are used throughout the drawings to depict like or similar elements of the utensil attachment. For the purposes of presenting a brief and clear description of the present invention, the preferred embodiment will be discussed as used for encouraging a child to consume an adequate amount of food. The figures are intended for representative purposes only and should not be considered to be limiting in any respect.

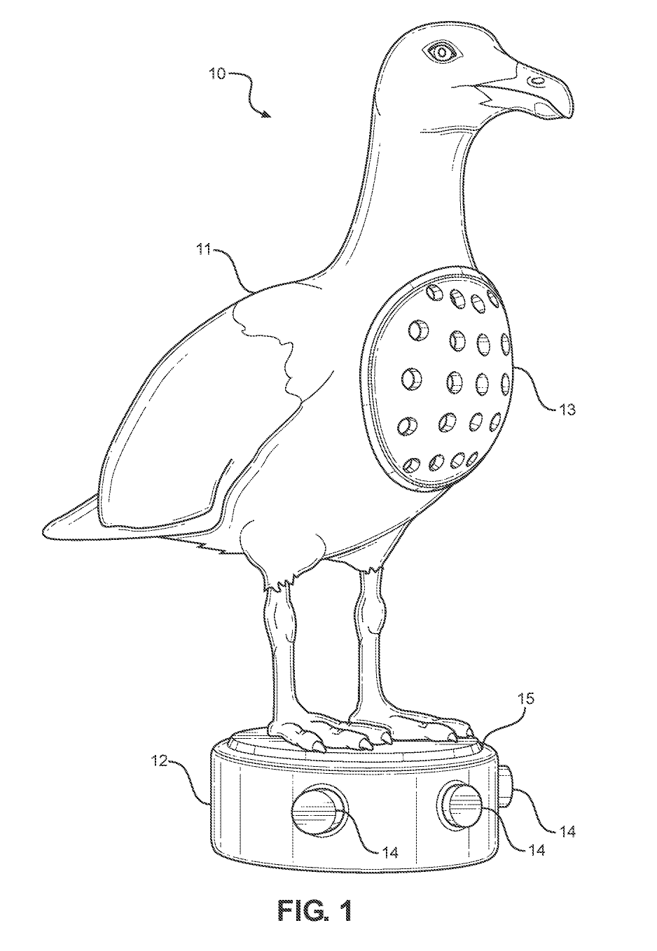

Referring now to FIG. 1, there is shown a perspective view of a utensil attachment according to the present invention. The utensil attachment 10 includes a base 12 having a housing 11 affixed to an upper side 15 thereof. In the shown embodiment, the base 12 is cylindrical. However, the base 12 can include alternate shapes, such as cubical, spherical, or cubical, in alternate embodiments. In the shown embodiment, the housing 11 is adapted to resemble a bird and includes a pair of legs, a beak, and a pair of wings. However, the housing 11 can have any ornamental appearance as desired and is not limited to a shape resembling a bird. In some embodiments, the housing 11 is configure such that the center of gravity of the housing 11 is positioned over a central portion of the base 12, so as to provide additional structural stability to the utensil attachment 10.

A speaker 13 is disposed on the housing 11 and is configured to emit sound therefrom. In the shown embodiment, the speaker 13 is disposed centrally on a forward facing portion of the housing, such that the speaker is oriented toward the individual as they use the utensil attachment 10. A plurality of control buttons 14 are disposed on the base 12 for controlling the various electronic components of the utensil attachment 10. In alternate embodiments, the controls buttons 14 are disposed on the housing 11. Further, in the shown embodiment, an upper portion of the base 12 includes a perimeter that is less than a perimeter of a lower portion of the base, such that the upper portion of the base 12 forms a pedestal to which the housing 11 is affixed, providing greater structural support to the housing 11.

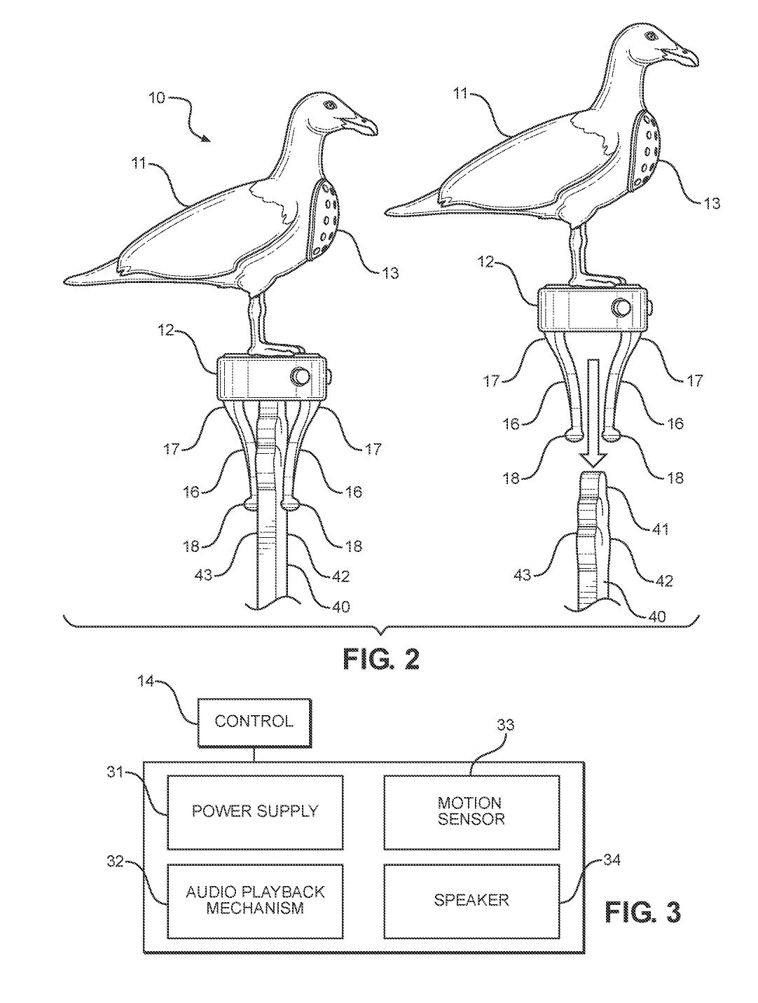

Referring now to FIGS. 2 and 3, there is shown a side view of a utensil attachment according to the present invention being removably secured to an eating utensil and a diagram of the electronic components of a utensil attachment according to the present invention, respectively. A fastener is affixed to a lower side of the base 12 for securing the utensil attachment 10 to the upper end 41 of an eating utensil 40. In the shown embodiment, the fastener is a clip including a pair of retaining members 16. Each retaining member 16 is attached to a perimeter edge of the base 12. The retaining members 16 are biased toward one another, allowing the retaining members 16 to frictionally engage the eating utensil 40. The retaining members 16 is configured to secure the housing 11 to any typical flatware utensil, such as a fork, knife, spoon, or the like.

The inner surfaces of the retaining members 16 contact the front face 42 and the rear face 43 of the utensil 40 when secured thereto. Each retaining member 16 includes an upper end 17 affixed to the base 12 and a lower end 18 that grips the utensil 40. In the shown embodiment, the lower ends 18 of the retaining members 16 include a bulbous tip that engages each side of the utensil. The bulbous tip of the retaining members 16 may be grasped by a user to facilitating easy attachment and detachment of the device to and from a utensil 40.

The electronic components of the utensil attachment 10 may be disposed within the housing 11 or within the base 12. The utensil attachment includes a power supply 31 operably connected to a motion sensor 33 and an audio playback mechanism 32. In one embodiment, the power supply 31 comprises a removable, replaceable battery. In an alternate embodiment, the power supply 31 comprises a rechargeable battery. The audio playback mechanism 32 includes various encouraging sounds and phrases stored thereon and is configured to emit the stored audio through the speaker 34.

The motion sensor 33 is configured to detect movement of the housing 11. The motion sensor 33 is operably connected to the audio playback mechanism 32 and speaker 34. If the motion sensor 33 does not detect motion of the housing 11 for a certain time interval, the audio playback mechanism 32 is configured to automatically emit. In some embodiments, the controls 14 can be utilized to manually control various electronic components. For example, the control 14 can be configured to turn the device on and off for selectively activating or deactivating the motion sensor 33. Additionally, the control 14 may be configured to selectively activate the audio playback mechanism 32, allowing a parent or guardian to manually emit an encouraging sound from the device.

In use, the housing 11 can be secured to a utensil 40, and the utensil 40 given to a child. The child can use the utensil 40 to eat as normal. When activated, the motion sensor 33 continuously monitors for motion of the housing 11. If the child puts the utensil 40 down, or if the utensil 40 is otherwise motionless for a predetermined amount of time, the audio playback mechanism 32 emits an encouraging sound of phrase in order to encourage the child to resume eating. In this way, the utensil attachment 10 automatically encourages a child to consume an adequate amount of food, allowing the parent or guardian to complete other tasks while the child is eating without having to continuously monitor whether the child is eating an adequate amount of food.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A utensil attachment, comprising:
a base having an upper side and a lower side;
a housing affixed to the upper side of the base;
a fastener affixed to the lower side of the base;
a power supply operably connected to a motion sensor and an audio playback mechanism, the audio playback mechanism including a speaker disposed on the housing;
wherein the motion sensor is configured to detect movement of the housing, and wherein the audio playback mechanism is configured to activate and emit sound through the speaker if the motion sensor detects no motion for a predetermined amount of time.

2) The utensil attachment of claim 1, wherein the fastener comprises a clip including a pair of retaining members biased toward each other, wherein an inner surface of each retaining member contacts opposing sides of a utensil when the clip is secured thereto.

3) The utensil attachment of claim 2, wherein each retaining member includes a rounded tip that engages a side of the utensil.

4) The utensil attachment of claim 2, wherein each retaining member is affixed to the base along a perimeter edge of the base.

5) The utensil attachment of claim 1, further comprising a control disposed on the base.

6) The utensil attachment of claim 5, wherein the control is configured to selectively activate the motion sensor.

7) The utensil attachment of claim 5, wherein the control is configured to selectively activate the audio playback mechanism.

8) The utensil attachment of claim 1, wherein the power supply comprises a battery removably disposed within the base.
